(19) United States
(12) Patent Application Publication
(10) Pub. No.: US 2015/0356606 A1
(43) Pub. Date: Dec. 10, 2015

(54) METHOD OF GEOLOCATION

(71) Applicant: Bruno van Boucq, Beauvechain (BE)

(72) Inventor: Bruno van Boucq, Beauvechain (BE)

(21) Appl. No.: 14/298,127

(22) Filed: Jun. 6, 2014

(51) Int. Cl. G06Q 30/02; H04H 20/61; H04W 4/02; H04W 4/20

(52) U.S. Cl. CPC G06Q 30/0261; H04W 4/206; H04H 20/61; H04W 4/02; G06Q 30/0259; G06Q 30/0267

(57) ABSTRACT

A method of geolocation assigning an Internet user a geolocation within a territory determined on the basis of the geolocation of his IP address. A method of broadcasting advertising announcements according to the method of geolocation.

### CROSS REFERENCE TO RELATED APPLICATION

This application claims priority to European Application No. 14169111.3 filed May 20, 2014, the entirety of which is incorporated herein by reference.

### FIELD OF THE INVENTION

The present invention relates to a method of geolocation. More specifically, the present invention relates to a method of geolocation for broadcasting advertising announcements.

### BACKGROUND

Non-intrusive advertisements, open by default, are known for announcing goods and services on the Internet when the user goes to particular pages to which these advertisements are linked. This allows advertisers, who possibly sponsor the website where their advertising appears, to broadcast an advertisement that will appear on the Internet user's screen.

However, in most cases these advertisements relate to national retailers and suppliers of services that the internet user can only locate precisely after undertaking additional search steps. For example, after viewing the advertisement (announcement) and if the latter is of interest to the internet user, the latter must, on the basis of the information mentioned in the advertisement, consult a map (plan) for locating the advertiser or at least his point of sale more precisely. Thus, the Internet user is often led to receive and view announcements from advertisers whose points of sale can be relatively remote from the place where he is located at the time when the advertisement is displayed. This is neither of benefit to the internet user, who generally has no interest in making his way to a distant point of sale, nor to the advertiser, whose announcement does not have any real impact on internet users located at too great a distance from his point of sale.

That is why geolocation systems were developed, with the aim of locating the internet user as precisely as possible in order to send him announcements that are as relevant as possible, i.e. announcements from advertisers whose points of sale are close to his location.

Such a method is for example known from the document WO-A-2002/103997, which describes various ways to geolocate an internet user. These can be geolocation by the internet user himself, if he accepts to specify his geolocation; geolocation with the help of a database that holds information of the internet user; if such a database exists; or geolocation based on the IP address of the internet user, with this last method of geolocation always being possible. The internet user's IP address, that is the IP address of the connection of the equipment that he is using to a computer network, corresponds to an identification number assigned permanently or temporarily to each device connected to an information network using the “internet protocol” (communication protocol designed for use by the internet). The geolocation information and the IP address can be matched in a database to later recover the geolocation information from the IP address.

For the advertiser, this method is interesting because his announcement is broadcast to localized internet users. Moreover, as his announcement is more relevant as regards the internet user's geolocation than a non-local announcement, it has much more chance of arousing the internet user's interest.

Unfortunately, geolocation of the Internet user according to his IP address is imprecise and does not allow location of the internet user at the exact place where he is located. The IP address of an internet user depends on the Internet provider, who does not necessarily always link this address to the precise place where the internet connection is located.

In the interests of the advertiser, but also so that the internet user receives announcements corresponding better to his geolocation, other methods have been developed. For example, document WO-A-2013/057269 discloses a method of distribution of advertisements based on geolocation by at least one of the following means: by IP address, by the internet user's internet browser, by a geolocation service of this internet browser, or by the internet user himself who specifies his geolocation.

However, in the majority of cases, the internet user refuses to be geolocated by his internet browser and the latter's geolocation service, and geolocation is only possible by IP address. In practice, internet users IP addresses that are located within a territory of several [square] kilometres can be geolocated in a grouped manner at the same point of latitude and longitude, called the geolocation point of IP addresses, which does not correspond to the real geolocation of the internet users.

An important disadvantage of the geolocation of internet users merely by the geolocation of their IP addresses is that advertising announcements intended for the point at which the internet users' IP addresses are geolocated are distributed to internet users who are sometimes located at a considerable distance from this point. The geolocation point of a group of IP addresses may also be located outside the area in which the internet users who have these IP addresses are located.

Another disadvantage is that certain areas seem empty of any internet users, and so advertising announcements intended for these areas cannot be broadcast, when in reality there are internet users present in these areas that appear empty.

Another particularly problematical situation concerns internet users whose IP addresses are grouped together even though the internet users are spread over an extremely wide area. For example, in Belgium, many IP addresses are geolocated in a grouped manner near to Ninove, although the internet users who have these IP addresses are located all over the country.

### DISCLOSURE OF THE INVENTION

One object of the present invention is to provide a method of geolocation allowing the assignment of a precise geolocation to an Internet user whose IP address is known but who is not geolocated by geolocation methods other than by IP address.

Another object of the present invention is to provide a method of geolocation allowing the assignment of a geolocation to an internet user whose IP address is known that is precise and close to his real geolocation.

An object of the present invention is the determination, for a point at which IP addresses are geolocated, of a territory that corresponds to it and that covers the Internet users whose IP addresses are geolocated at the said point.

An object of the present invention is to provide a geolocation method that allows an internet user to be directed towards local advertising campaigns.

An object of the present invention is to allow advertisers to broadcast announcements in predefined geographic broadcasting zones.

In order to meet the objects of the present invention, a method of geolocation is provided, following the invention, for an internet user whose IP address is known, allowing a geolocation point for his IP address to be determined. The method is characterised in that the internet user is assigned a geolocation on a territory corresponding to the geolocation point of his IP address.

The advantage of such a method is that internet users whose IP addresses are geolocated at the same point are distributed over a given territory. Compared to the situation in which the internet users geolocated only by their IP address seem to be grouped at the geolocation point of their IP address and receive all the local advertising corresponding to this point, geolocation over a territory reduces the probability that an area appears empty of internet users and that no local advertising can be distributed there, even though there could be internet users present there. In other words, the method according to the present invention minimizes the probability that a broadcasting zone for advertising announcements does not cover any internet users.

Advantageously, according to the invention, the assignment of a geolocation to the Internet user within the territory corresponding to the geolocation point of his IP address is made so as to obtain a substantially homogeneous distribution of geolocations of internet users over the territories corresponding to the geolocation points of their IP addresses.

A substantially homogeneous distribution of internet users enables the internet users to be well distributed among the broadcasting zones of advertising announcements. This also enables the advertising announcements to be well distributed among the internet users.

In one particular embodiment of the present invention, the assignment of a geolocation to the internet user within the territory corresponding to the geolocation point of his IP address is made so as to avoid an excessive density of geolocations of internet users in the regions where the territories corresponding to several geolocation points of IP addresses overlap.

This embodiment of the invention resolves a problem that could arise when the territories corresponding to several geolocation points of IP addresses overlap. If the assignment of the geolocation of the internet user does not take into account that the territory corresponding to his IP address and the other internet users whose IP addresses are geolocated at the same point as him, in other words, if the assignment does not take other territories into account, the area where several territories, corresponding to several IP addresses, overlap will have a higher density of Internet users than the areas where a single territory exists. This embodiment of the invention assigns geolocations to internet users so as to avoid and excessive density of internet users.

Preferably, in an embodiment of the invention, the assignment of a geolocation to the internet user within the territory corresponding to the geolocation point of his IP address excludes a part of the territory. Excluding a part of the territory enables, for example, internet users not to be geolocated in areas of sea, lake or forest, where the density of internet users is a priori low. This also enables the exclusion of neighbouring countries or languages for which the advertisements would not be pertinent.

Advantageously, in an embodiment of the invention, the assignment of a geolocation to the internet user within the territory corresponding to the geolocation point of his IP address takes account of the internet user's data. These details can come from the internet service provider, such as his IP address, from a form the internet user has previously completed, from a cookie or from another source. They can give indications as to the probable geolocation of the internet user. For example, an internet user located close to the Franco-Belgian frontier but using a Belgian access provider is more likely to be in Belgium than in France; or if he access a .be website he is also more likely to be in Belgium than in France.

Moreover, in one particular embodiment of the invention, the assignment of a geolocation to the internet user within the territory corresponding to the geolocation point of his IP address takes account of the language in which the internet user uses the internet. An internet user located close to a linguistic border will be preferentially assigned a geolocation on the side of the border corresponding to the language in which he is using the internet. This embodiment of the invention is particularly useful in countries such as Belgium that have several linguistic regions.

According to an embodiment of the invention, the territory corresponding to the geolocation point of the internet user's IP address is determined by comparison of geolocation data by IP address and geolocation data from at least one other method of geolocation, said data concerning several other internet users geolocated by their IP address and geolocated by at least one other method of geolocation.

Some internet users are geolocated both by their IP address and by at least one other geolocation method. By comparing the data concerning the geolocation points of their IP address and the data concerning the geolocation(s) by the other geolocation method(s), more precise than geolocation by IP address, it is possible to determine territories corresponding to geolocation points of IP addresses.

This method is particularly advantageous, as it enables the geolocation assigned to the internet user to be close to his real geolocation. For example, a geolocation point for IP addresses can in reality be far from the internet users whose IP addresses are geolocated at that point. As the present method determines the territory corresponding to a geolocation point of IP addresses in function of internet users also geolocated by one or more geolocation method(s) other than geolocation by IP address, the territory corresponding to a geolocation point for IP addresses is close to the internet users whose IP addresses are geolocated at that point, and not necessarily close to the point itself.

According to an embodiment of the present invention, the at least one other method of geolocation is performed via an internet browser and a geolocation service of this internet browser. Furthermore, according to an embodiment of the present invention, the at least one other method of geolocation is performed via an internet browser and a geolocation service of this internet browser via the HTML5 technology or a later version of the HTML language system.

Geolocation that is effected via the internet browser and the geolocation service of this internet browser can be based, for example, on “Google Service Location®” (Google Inc., Mountain View, USA) or on “Microsoft Service Location®” (Microsoft Corporation, Redmond, USA) or on the “Apple Location Service®” (Apple Inc., California, USA) or else on other geolocation services.

Geolocation can also use APIs or Programming Interfaces. In particular, geolocation can use one or more APIs in HTML5 or in a mark-up language for the creation of web pages.

Internet browsers such as Chrome® (Google Inc., Mountain View, USA), Firefox® (Mozilla Foundation, SeaMonkey, Mountain View, USA) and Opera® (Opera Software, Oslo) more particularly use the geolocation service of “Google Location®” (Google Inc., Mountain View, USA).

The internet browser “Internet Explorer®” (Microsoft Corporation, Redmond, USA) more particularly uses the geolocation service of “Microsoft Location®” (Microsoft Corporation, Redmond, USA).

The internet browser “Safari®” (Apple Inc., California, USA) more particularly uses the geolocation service of “Apple Location®” (Apple Inc., California, USA).

Of course, other internet browsers as well as other geolocation services associated with these internet browsers can be considered in the context of the present invention.

The geolocation services make it possible to identify at least one SSID (Service Set Identifier or name of a wireless network corresponding to a unique number) and/or identify the IP address and/or collect information on the 3G (third generation) masts and/or picocells or femtocells and/or define the GPS (“Global Positioning System”) and/or GPRS (“General Packet Radio Service”) coordinates of said internet user. These geolocation services can therefore supply one or more of these pieces of information (IP, SSID, 3G, GPS) depending on the internet browser.

Preferably, according to the invention, the mark-up language system for web page creation is an HTML 5.0 language system or a higher or later version of an HTML (“Hypertext Markup Language”) language system.

This geolocation via an Internet browser and a geolocation service of this internet browser is precise to a few tens of metres or a few metres, which allows internet users to be geolocated very well and also to have very precise data on the geolocations of internet users whose IP addresses are geolocated at a geolocation point for IP addresses.

According to an embodiment of the invention, the at least one other method of geolocation is based on a geolocation performed by the Internet user himself who specifies his geolocation. This embodiment of the invention also enables internet users to be very precisely geolocated and also to have very precise data on the geolocations of internet users whose IP addresses are geolocated at a geolocation point for IP addresses.

According to an embodiment of the invention, a territory corresponding to a geolocation point for IP addresses includes substantially all the Internet users whose IP address is geolocated at this point and who are geolocated by at least one other method of geolocation.

In this embodiment of the invention, a territory corresponding to a geolocation point for IP addresses is a zone that covers practically all the Internet users whose IP address is geolocated at the point considered and who are geolocated by at least one other method of geolocation. This allows Internet users who are geolocated only by their IP addresses to have an assigned geolocation close to their real location, as these territories are fairly realistic.

According to an embodiment of the invention, the determination of the territory corresponding to a geolocation point for IP addresses includes processing of geolocation data. Processing of geolocation data allows, for example, an internet user who is too far removed from the others to be ignored, or only areas where the density of internet users exceeds a certain threshold to be considered in determining the territories. It can also include statistical processing of the data, allowing for example the geolocation of an internet user to whom a geolocation must be assigned to be decided.

According to an embodiment of the invention, the territory corresponding to a geolocation point for IP addresses has the form of a circle that passes through the two Internet users most distant from one another whose IP address is geolocated at this point and who are geolocated by at least one other method of geolocation. A circular territory such as this one is particularly simple to determine.

According to an embodiment of the invention, an Internet user whose IP address is geolocated at a point corresponding to a territory deemed too large based on predefined criteria is assigned a geolocation at a national level. According to an embodiment of the invention, an internet user whose IP address is geolocated at a point corresponding to a territory deemed too large based on a predefined criterion is assigned a geolocation at a non-local level. If a territory is too large for a given application, the assignment of a geolocation within this territory is too imprecise to fulfil the objective of the application. For example, if an application of the geolocation method is the distribution of local advertising announcements, a territory of several hundred [square] kilometres might not make sense. The internet user is therefore assigned a geolocation at a national level or at a non-local (for example, regional) level, and he will not receive local advertising announcements but rather more general advertisements, such as national or regional advertising announcements.

Advantageously, the geolocation method of the present invention is suitable for at least one of fixed and portable computers, data tablets, mobile phones (smartphones), systems equipped with a Wi-Fi system, digital televisions, radios and augmented reality systems. The invention is useful both for internet users browsing on fixed equipment such as their home or office computers, and who are concerned with advertising announcements linked to a place in which they are often located, and for internet users browsing on mobile devices who could be concerned with products or services available in the place in which they are currently located. For example, an Internet user using augmented reality glasses could see advertising announcements with offers from the shops he passes.

The invention comprises a method of geolocation for the broadcasting of advertising announcements. The invention comprises in particular a method of geolocation for the broadcast of local advertising announcements. This allows the Internet user to receive targeted announcements, for example linked to points of sale close to his geolocation.

In a particular embodiment, the local advertising announcements are distributed in priority to internet users geolocated in the most precise way. For example, local advertising announcements are first distributed to internet users who have specified their geolocation, then to Internet users located by an internet browser and the geolocation service of this internet browser, and finally to internet users geolocated only by their IP addresses and to whom a geolocation has been assigned in a territory corresponding to the geolocation point of their IP address. This embodiment of the invention enables an increase in the probability that an advertising announcement is distributed to an Internet user who is really located in the broadcasting zone of the said advertising announcement.

The invention comprises advantageously a computer program product to implement the method according to the invention.

The invention comprises, moreover, a communication system, and more particularly a communication system for the display of advertising announcements, that implements a geolocation method according to the invention.

Other embodiments of the system according to the invention are indicated in the appended claims.

### BRIEF DESCRIPTION OF THE DRAWINGS

Other features, details and advantages of the invention can be seen from the description given below, non-exhaustively and referring to the appended drawings.

FIG. 1 illustrates a scheme of a communication system.

FIG. 2 illustrates an operating scheme of a communication system.

FIG. 3 illustrates the display of an advertising window according to the communication system.

FIG. 4 illustrates another advertising window according to the communication system.

FIG. 5 illustrates a first tool allowing the advertiser to define the broadcasting zone of the advertising announcement.

FIG. 6 illustrates a second tool allowing the advertiser to define the broadcasting zone of the advertising announcement.

FIG. 7 illustrates a tool that allows the advertiser to create his announcement by defining a series of parameters.

FIG. 8 is a schematic view of a zone covering the geolocation points of IP addresses according to the present invention.

FIG. 9 illustrates the geolocation of internet users whose IP address is geolocated at one of the geolocation points of IP addresses according to the present invention.

FIG. 10 illustrates an operating scheme according to the present invention.

FIG. 11 illustrates a determination of territories corresponding to geolocation points of IP addresses according to an embodiment of the present invention.

FIG. 12 illustrates a determination of territories corresponding to geolocation points of IP addresses according to another embodiment of the present invention.

FIG. 13 illustrates a variation in the determination of territories corresponding to geolocation points of IP addresses according to an embodiment of the present invention.

FIG. 14 illustrates an assignment of geolocations to internet users according to an embodiment of the present invention.

FIG. 15 illustrates the assignment of geolocations to internet users in territories corresponding to geolocation points of their IP addresses according to another embodiment of the present invention.

FIG. 16 illustrates an operating scheme according to the present invention.

### EMBODIMENTS OF THE INVENTION

The present invention is described with particular embodiments and references to figures but the invention is not limited by these. The drawings or figures described are only schematic and are not limiting. In the drawings, certain elements are not to scale.

In the figures in which an element is represented several times, such as in certain figures representing numerous internet users, the number of times that an element is present is not necessarily close to the number of time that this element is present in embodiments of the invention.

In the figures, identical or analogous elements may have the same references.

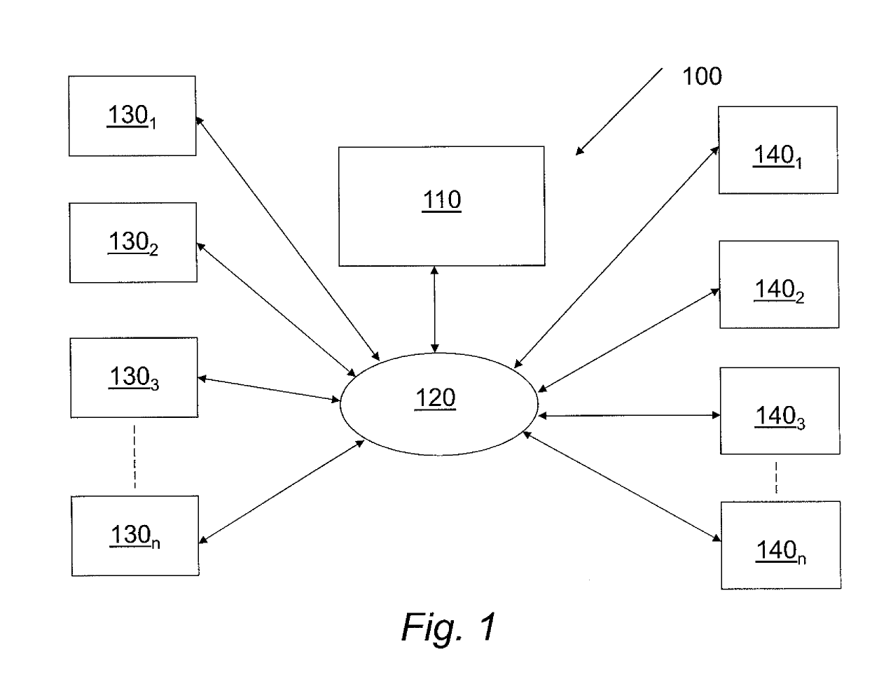

FIG. 1 illustrates a communication system 100. The system 100 can be regarded as comprising a platform of a service provider 110 that constitutes the internet interface 120 for providing a platform (not shown) with which a plurality of service providers and advertisers 130₁, 130₂, 130₃, . . . 130ₙ (the letter n can be any whole number) can interact. A plurality of internet users 140₁, 140₂, 140₃, . . . , 140ₙ (the letter n can be any whole number) surfing and using the internet 120 can access the information “posted” by a supplier of services or an advertiser 130₁, 130₂, 130₃, . . . , 130ₙ on the various partner sites via internet 120. The “posted” information preferably comprises local information, which is information relating to a particular geographic zone defined by geographic coordinates (longitude and latitude) predetermined by each internet user 140₁, 140₂, 140₃, . . . , 140ₙ. Depending on the geolocation of each internet user 140₁, 140₂, 140₃, . . . , 140ₙ, different information can be supplied by the service provider 110 according to the subscription conditions to which each supplier of services or advertiser 130₁, 130₂, 130₃, . . . , 130ₙ has subscribed.

An internet user from the pluralities of internet users 140₁, 140₂, 140₃, . . . , 140ₙ surfing and using the internet can use, in a non-limiting manner, a fixed or portable computer, a data tablet, a mobile telephone (smartphone), a system fitted with Wi-Fi, a digital television, a radio, or a augmented reality system such as Google Glass (Google Inc., Mountain View, USA).

Even though FIG. 1 shows that the service provider 110 interacts with the supplier of services or advertiser 130 via the internet 120, it is envisaged that the service provider 110 and supplier of services or advertiser 130 can interact in other ways, for example by letter, by telephone, by email, etc.

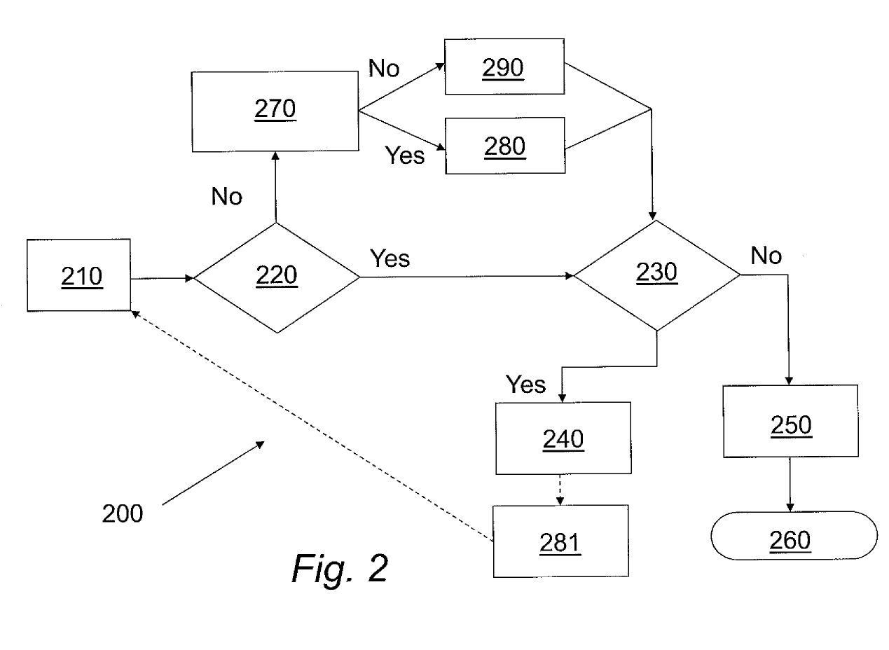

FIG. 2 illustrates an operating scheme 200 of a communication system.

According to a first route according to the operating scheme 200, following calling of the advertising window 210 on the website consulted by the internet user, the communication protocol HTTP (hypertext transfer protocol) 220 is checked by the internet browser to determine whether the internet user has already been geolocated previously and already possesses a cookie (evidence of connection), which makes it possible to determine whether the geolocation of said Internet user is already recorded in a browser support, for example a fixed or portable computer, a data tablet, a mobile phone, or an augmented reality system. If the internet user has already been previously geolocated and if his geolocation has already been recorded in the communication system, said communication system will directly verify in the database comprising the advertising announcements 230 whether a local advertisement 240 can be displayed according to the precise geolocation of the internet user. If the internet user's geolocation corresponds to a local advertising announcement 240, then this local advertising announcement 240 will be displayed.

Optionally, following the display of said local advertising announcement 240, if the internet user so desires he can, by clicking on a button (“other geolocation”) that directs him to a platform where he can modify the existing cookie, modify his geolocation more precisely by specifying it on said platform 281, for example by giving a postcode or a precise address. In this case, the previous cookie is erased from the browser support and replaced with the new one that is recorded in said browser support via said platform 281. Following this cookie changing operation, the communication system according to the invention starts again from the step of calling the advertising window 210.

In the opposite case, if no local announcement corresponds to the internet user's geolocation, then the communication system will go to a secondary program 250, which will allow a non-local advertising announcement 260, for example a national advertising announcement, to be displayed.

According to a second route according to the operating scheme 200, following calling of the advertising window 210 on the website consulted by the internet user, the communication protocol HTTP 220 is checked by the internet browser to determine whether the internet user has already been geolocated previously and already possesses a cookie (evidence of connection), which makes it possible to determine whether the geolocation of said internet user is already recorded in a browser support, for example a fixed or portable computer, a data tablet, a mobile phone, or an augmented reality system. If the internet user has not yet been geolocated previously and if consequently his geolocation is not yet known by the internet browser, said internet browser will display a pop-up (message) 270 asking said internet user whether he wants to be geolocated. If said internet user refuses to be geolocated or ignores the pop-up, the communication system will even so locate the internet user according to the IP address 290 of his connection to an information network, which leads to the creation of a cookie, whose lifetime is variable depending on the browser support. For example, the lifespan of the cookie can be shorter for a mobile browser support than for a fixed browser support.

This geolocation by IP address can be made for example via a Maxmind® correspondence database (Maxmind of Waltham, Mass., USA). Following this geolocation of the internet user according to his IP address 290, said communication system will directly verify in the database comprising the advertising announcements 230 whether a local advertisement 240 can be displayed according to the geolocation of the internet user. If the internet user's geolocation corresponds to a local advertising announcement 240, then this local advertising announcement 240 will be displayed.

Optionally, following the display of said local advertising announcement 240, if the internet user so desires he can, by clicking on a button (“other geolocation”) that directs him to a platform where he can modify the existing cookie, modify his geolocation more precisely by specifying it on said platform 281, for example by giving a postcode or a precise address. In this case, the previous cookie is erased from the browser support and replaced with the new one that is recorded in said browser support via said platform 281. Following this cookie changing operation, the communication system according to the invention starts again from the step of calling the advertising window 210.

In the opposite case, if no local announcement corresponds to the Internet user's geolocation, then the communication system will go to a secondary program 250, which will allow a non-local advertising announcement 260, for example a national advertising announcement, to be displayed.

According to a third route according to the operating scheme 200, following calling of the advertising window 210 on the website consulted by the internet user, the communication protocol HTTP 220 is checked by the internet browser to determine whether the internet user has already been geolocated previously and already possesses a cookie (evidence of connection), which makes it possible to determine whether the geolocation of said internet user is already recorded in a browser support, for example a fixed or portable computer, a data tablet, a mobile phone, or an augmented reality system. If the internet user has not yet been geolocated previously and if consequently his geolocation is not yet known by the internet browser, said internet browser will display a pop-up (message) 270 asking said internet user whether he wants to be geolocated.

If said internet user accepts being geolocated, this geolocation is carried out via the internet browser and its geolocation service (“location service”) 280 making it possible to identify at least one SSID and/or identify the IP address and/or collect information on the 3G masts, the femtocells or picocells and/or define the GPS and/or GPRS coordinates of said Internet user. Acceptance of pop-up 270 leads to the creation of a cookie, whose lifetime is variable depending on the browser support. For example, the lifespan of the cookie can be shorter for a mobile browser support than for a fixed browser support.

Following this geolocation of the internet user, said communication system will directly verify in the database comprising the advertising announcements 230 whether a local advertisement 240 can be displayed according to the precise geolocation of the internet user. If the internet user's geolocation corresponds to a local advertising announcement 240, then this local advertising announcement 240 will be displayed.

Optionally, following the display of said local advertising announcement 240, if the internet user so desires he can, by clicking on a button (“other geolocation”) that directs him to a platform 281 where he can modify the existing cookie, modify his geolocation more precisely by specifying it on said platform 281, for example by giving a postcode or a precise address. In this case, the previous cookie is erased from the browser support and replaced with the new one that is recorded in said browser support via said platform 281. Following this cookie changing operation, the communication system according to the invention starts again from the step of calling the advertising window 210.

In the opposite case, if no local announcement corresponds to the internet user's geolocation, then the communication system will go to a secondary program 250, which will allow a non-local advertising announcement 260, for example a national advertising announcement, to be displayed.

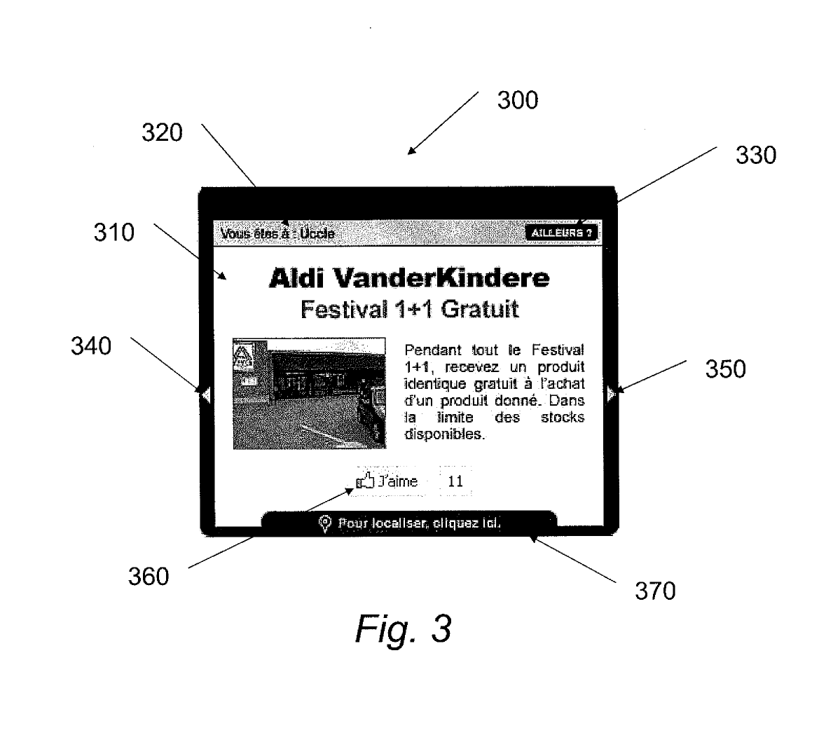

FIG. 3 illustrates an advertising window 300. This advertising window 300 comprises the advertising announcement 310 of the advertiser or of the supplier of services, statement of the location 320 of the Internet user, a link 330 allowing the internet user's location to be modified, arrows 340, 350 for moving onto another advertisement or for returning to a previous advertisement already viewed, a link 360 for indicating “like” on Facebook and a link 370 for viewing the precise location of the advertiser or of the supplier of services to which the advertising announcement 310 relates.

The format of the advertising window 300 is adapted depending on the internet browser support. It can for example be different for a mobile browser support and for a fixed browser support. The format of the advertising window 300 can be an IMU or other format depending on the advertiser's wishes and the predefined formats on internet pages.

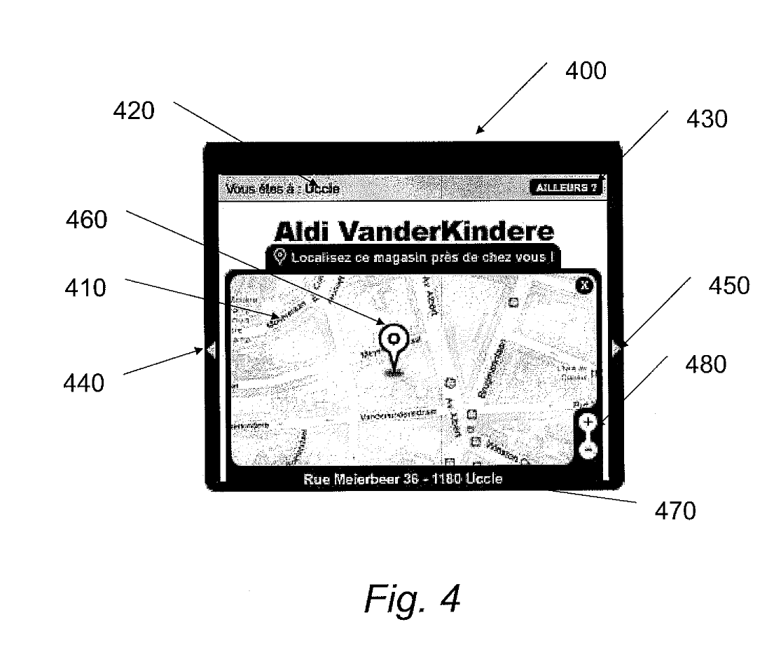

FIG. 4 illustrates the advertising window 400 that appears when the internet user makes use of link 370 for viewing the precise geolocation of the advertiser or of the supplier of services to which the advertising announcement 310 relates. This advertising window 400 comprises a map 410 for geolocating the advertiser or the supplier of services, statement of the geolocation 420 of the internet user, a link 430 allowing the internet user's geolocation to be modified, arrows 440, 450 for moving onto another advertisement or for returning to a previous advertisement already viewed, a tag 460 precisely stating the geolocation of the advertiser or of the supplier of services, statement of the precise address 470 of the advertiser or of the supplier of services and a button 480 for zooming in or out in the map 420 in order to facilitate geolocating the advertiser or the supplier of services.

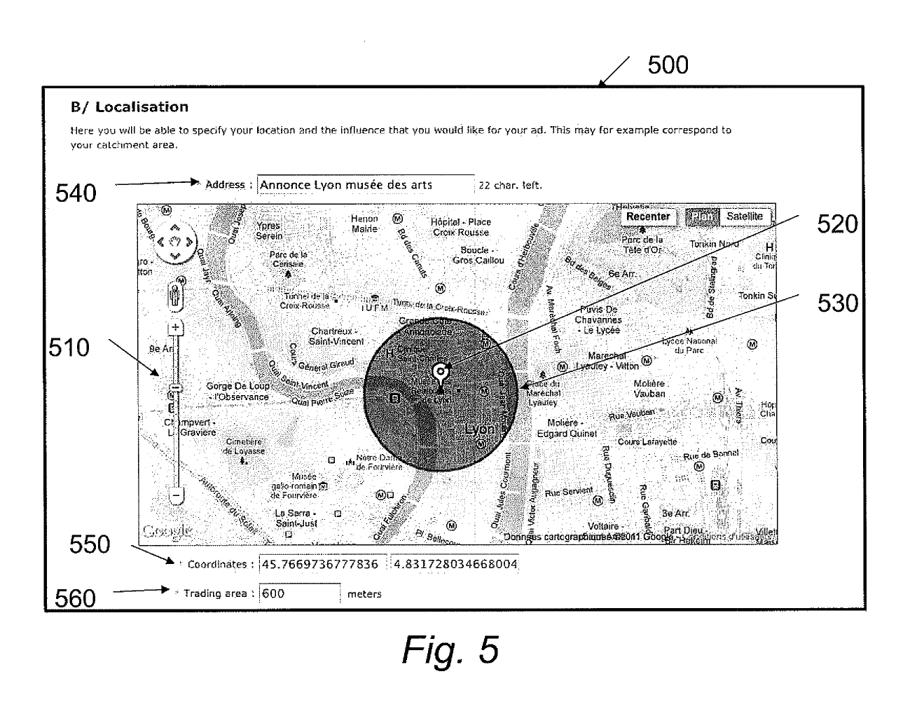

FIG. 5 illustrates a tool 500 that allows the advertiser or the supplier of services to define the precise place covered by his advertising announcement by identifying it either using a tag 520 on a map 510, or by entering the address 540 of said place, or by entering the geographic coordinates 550 of said place. Once said place is precisely defined, said tool allows the advertiser or the supplier of services to define the broadcasting zone 530 of his advertising announcement by defining a broadcasting zone 530 by postcode or with a circle. The broadcasting zone 530 can be located around the place to which the advertising announcement relates or elsewhere depending on the advertiser's target. The extent of the broadcasting zone as a circle is defined in metres 560. Even though FIG. 5 illustrates a circular zone of action around the place to which the advertising announcement relates, it is understood that this circular shape of the zone of action can have many different shapes and that this zone can be, for example, of triangular or rectangular shape, etc. The broadcasting zone can be calculated starting from a point (the geolocation of the shop) and a journey time for the internet user to arrive at this point. For example, the advertiser can decide that the broadcasting zone is an area such that an internet user situated in this area takes less than 15 minutes to arrive at his shop.

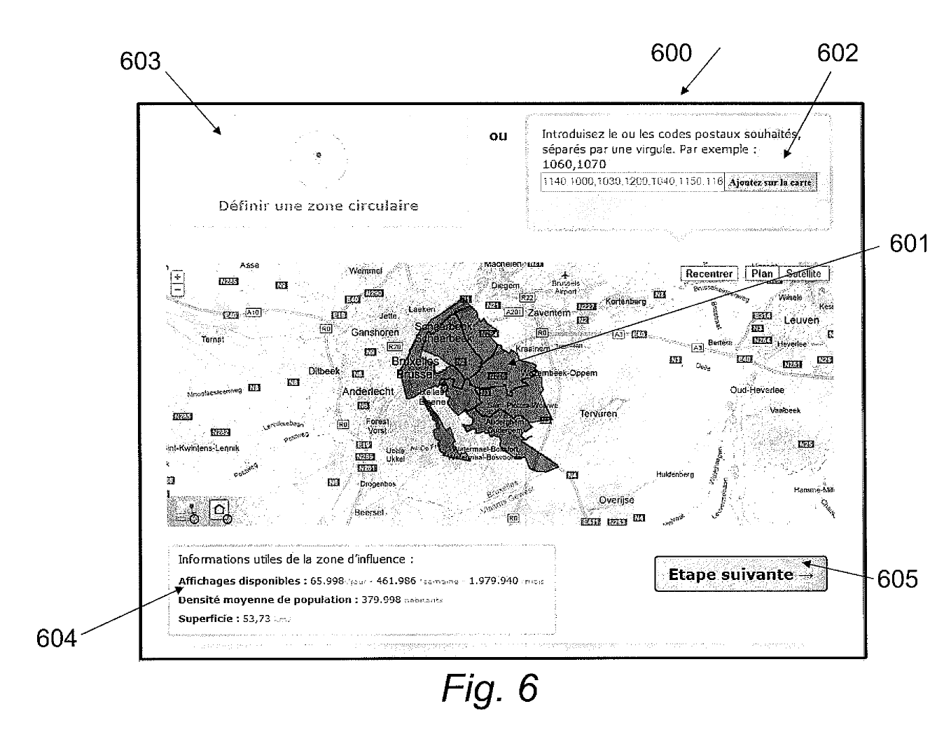

FIG. 6 illustrates a tool 600 that allows the advertiser or the supplier of services to define the place or the broadcasting zone 601 relating to his announcement according to the input of postcodes 602. The possibility of defining a circular zone is still offered 603. A frame 604 allows the advertiser to obtain additional information such as the number of displays available in the zone defined (per day, per week and per month), the average population density in the zone defined and the area of the zone defined. A button 605 allows the advertiser to pass to the next step of creating his announcement, once the broadcasting zone 601 is defined.

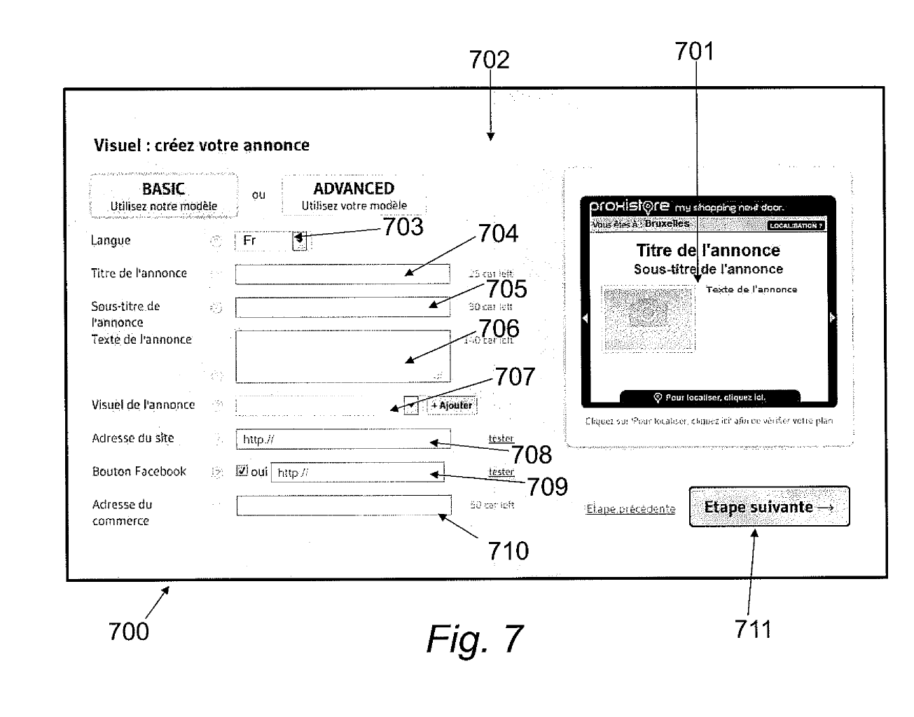

FIG. 7 illustrates a tool 700 allowing the advertiser to create his announcement by defining a series of parameters. This tool 700 comprises a first zone 701 and a second zone 702. The first zone 701 allows the advertiser to visualize his announcement according to the parameters that he enters in the second zone 702. Several text zones 703 to 710 allow the advertiser to define a whole series of parameters: language, title of the announcement, subtitle of the announcement, text of the announcement, visual of the announcement (image), URL address of a website, Facebook button, address of the business (point of sale). A button 711 allows the advertiser to pass to the next step of creating his announcement.

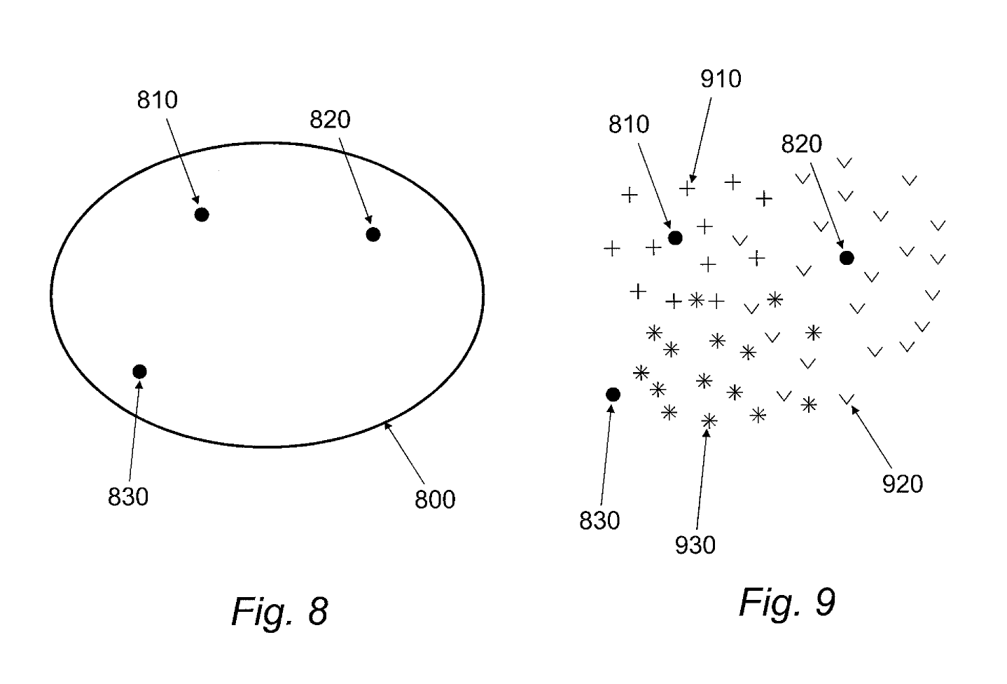

FIG. 8 is a schematic view of an area 800 covering the geolocation points of IP addresses. A geolocation can be assigned by IP address, but often internet users IP addresses that are located within a wide territory are geolocated in a grouped manner at the same point of latitude and longitude. The IP addresses are in fact grouped together in geolocation points of IP addresses. In the example of FIG. 8, only three geolocation points 810, 820, 830 of IP addresses appear in a certain region 800 even though internet users are in reality present throughout the region 800.

FIG. 9 illustrates the geolocation of internet users whose IP address is geolocated at one of the geolocation points of IP addresses. FIG. 9 represents by crosses (“X”) the internet users 910 whose IP addresses are geolocated at the geolocation point of IP addresses 810 and who are also geolocated via their Internet browser and their geolocation service 280 (see FIG. 2), via specification of their position on a platform 281, or via another method of geolocation; by “V”s the Internet users 920 whose IP addresses are geolocated at the geolocation point of IP addresses 820 and who are also geolocated via their internet browser and their geolocation service 280, via specification of their position on a platform 281, or via another method of geolocation; and by asterisks (“*”) the internet users 930 whose IP addresses are geolocated at the geolocation point of IP addresses 830 and who are also geolocated via their internet browser and their geolocation service 280, via specification of their position on a platform 281, or via another method of geolocation

The internet users 910 appear to be present over a certain territory, which is not necessarily included within the region 800 (see FIG. 8). Likewise, the internet users 920 appear to be present over a certain territory, which is not necessarily included within the region 800; and so on for the internet users 930, who appear to be present over a certain territory, which is not necessarily included within the region 800.

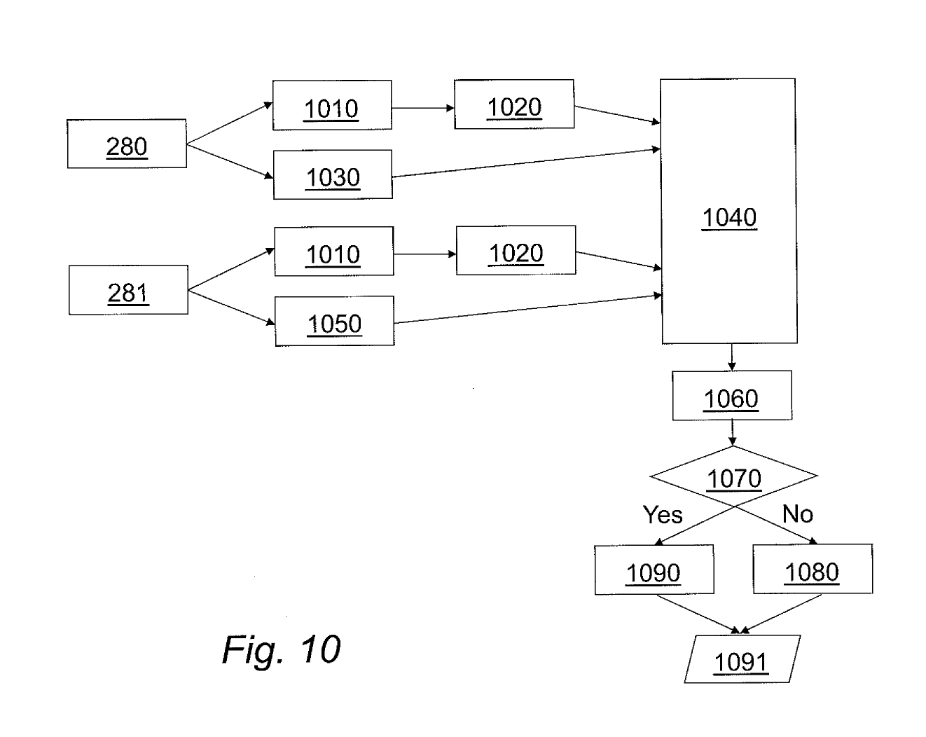

FIG. 10 illustrates an operational diagram enabling the creation of a database according to the present invention. When an internet user accepts to be geolocated by his Internet browser and his geolocation service 280, his IP address 1010 is used to determine the geolocation point 1020 of his IP address. A database 1040 then records the geolocation of his IP address. The geolocation 1030 determined by his internet browser and his geolocation service is also recorded in the database 1040.

When an internet user accepts to be geolocated by specifying his geolocation 281, his IP address 1010 is used to determine the geolocation point 1020 of his IP address. A database 1040 then records the geolocation of his IP address. The geolocation 1050 specified by the internet user is also recorded in the database 1040.

A step 1060 of determining territories is then carried out. Using the data from the database 1040, the geolocation point 810 of IP addresses (see FIG. 9) is associated with the geolocations of the internet users 910 geolocated via their internet browser and their geolocation service 280 or via the specification of their position on a platform 281 and whose IP address is geolocated at point 810. In the same manner, using the data from the database 1040, the geolocation point 820 of IP addresses (see FIG. 9) is associated with the geolocations of the internet users 920 geolocated via their internet browser and their geolocation service 280 or via the specification of their position on a platform 281 and whose IP address is geolocated at point 820, and so on for all the geolocation points of IP addresses considered, such as the point 830.

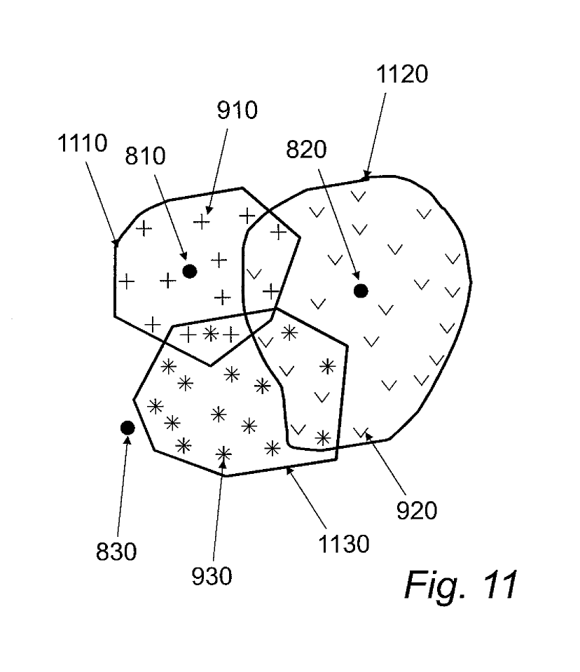

The following paragraphs describe different ways to carry out the step 1060 of determining territories according to the embodiments of the present invention, and with the support of FIGS. 11-13. The remainder of FIG. 10 will be described afterwards.

FIG. 11 illustrates the determination of territories corresponding to geolocation points of IP addresses according to an embodiment of the present invention. A territory covered by internet users 910 is considered as the territory 1110 corresponding to geolocation point 810 of IP addresses. In other words, the territory 1110 is a territory that covers substantially all the internet users 910 whose IP address is geolocated at the point 810 and who are geolocated by at least one other method of geolocation. The same is true for the geolocation point 820 of IP addresses: the territory 1120 is a territory that covers substantially all the internet users 920 whose IP address is geolocated at the point 820 and who are geolocated by at least one other method of geolocation. The same is true for the geolocation point 830 of IP addresses: the territory 1130 is a territory that covers substantially all the Internet users 930 whose IP address is geolocated at the point 830 and who are geolocated by at least one other method of geolocation, and so on for all the geolocation points of IP addresses considered.

According to an embodiment of the present invention, the territory 1110, 1120, 1130 has a predetermined geometric shape appropriate to cover substantially all the internet users 910, 920, 930 whose IP address is geolocated at the point 810, 820, 830 and who are geolocated by at least one other method of geolocation. For example, the territory 1110, 1120, 1130 can have the shape of a set of polygons, not necessarily contiguous, that covers substantially all the internet users 910, 920, 930 whose IP address is geolocated at the point 810, 820, 830 and who are geolocated by at least one other method of geolocation. It is clearly understood that all shapes of territories are possible, including circles, ellipses, polygons or sets or combinations of these.

It is possible that a geolocation point of IP addresses is situated outside the territory that corresponds to it, as is the case for the point 830 situated outside the territory 1130 in FIG. 11.

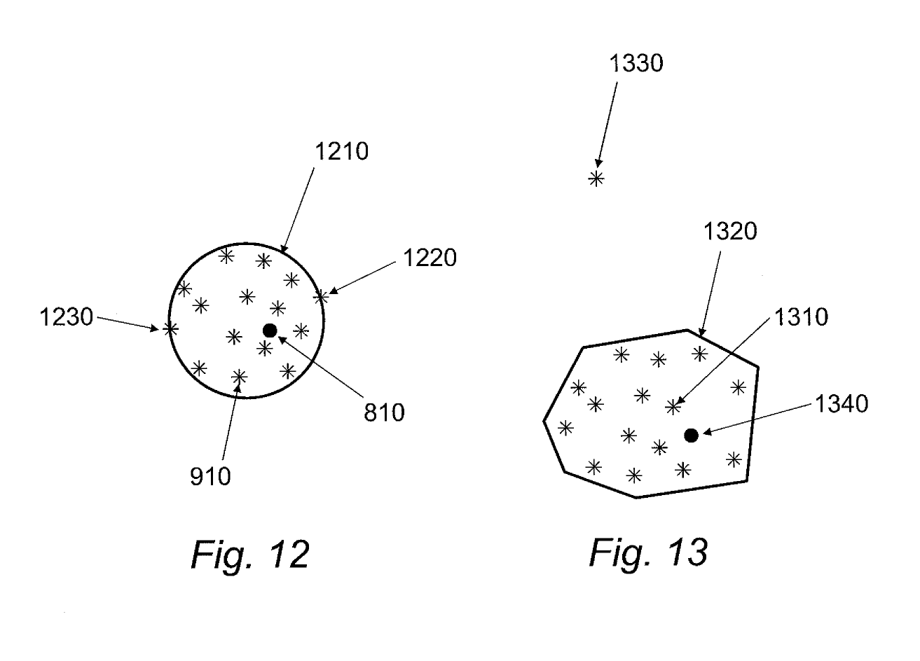

FIG. 12 illustrates the determination of territories corresponding to geolocation points of IP addresses according to another embodiment of the present invention. The territory of a geolocation point of IP addresses 810 can have the form of a circle 1210 that passes through the two Internet users 1220, 1230 most distant from one another whose IP addresses are geolocated at the point 810 and who are also geolocated via another method of geolocation.

The step 1060 of determining territories can comprise data processing.

FIG. 13 illustrates a variation in the data processing for the determination of territories corresponding to geolocation points of IP addresses according to an embodiment of the present invention. The step 1060 (see FIG. 10) of determining territories can comprise data processing so as, for example, not to take into account an internet user 1330 too distant from the other 1310 in the determination of the territory 1320 corresponding to the geolocation point 1340 of IP addresses, or to exclude a sparsely populated zone such as a forest or an expanse of water.

According to an embodiment of the present invention the step 1060 of determining territories comprises statistical data processing. This statistical processing can, for example, comprise only considering zones where the density of internet users exceeds a certain threshold in determining the territories.

According to an embodiment of the present invention the step 1060 of determining territories is carried out at regular intervals, these intervals being in general, but not limited to, between a few minutes and a few months.

Returning to FIG. 10, according to an embodiment of the present invention, the step 1060 of determining territories is followed by a step of verifying the size of the territories 1070. If a territory corresponding to a geolocation point of IP addresses is too large 1080, a local advertisement might not be pertinent across the whole of this territory. The decision to consider the territory as “too large” is based on an objective criterion, for example the area. In this case, if the territory is too large, it is called “non-local”. This can occur, for example, when the IP addresses of an entire country are geolocated at the same geolocation point of IP addresses. A non-local territory is therefore a territory too large for a local advertisement to be pertinent. A national territory is an example of a non-local territory. A territory of several hundred [square] kilometres could be a non-local territory, which depends on the definition of the criterion judging that a territory is “too large”.

If a territory corresponding to a geolocation point of IP addresses is not too large 1090, the internet users whose IP addresses are geolocated at this point and who are geolocated only by their IP addresses are then assigned a geolocation within this territory.

The information about the geolocation points of IP addresses, including their latitude and longitude coordinates; their corresponding territories and the fact of whether or not these territories are “too large” are recorded in a database 1091.

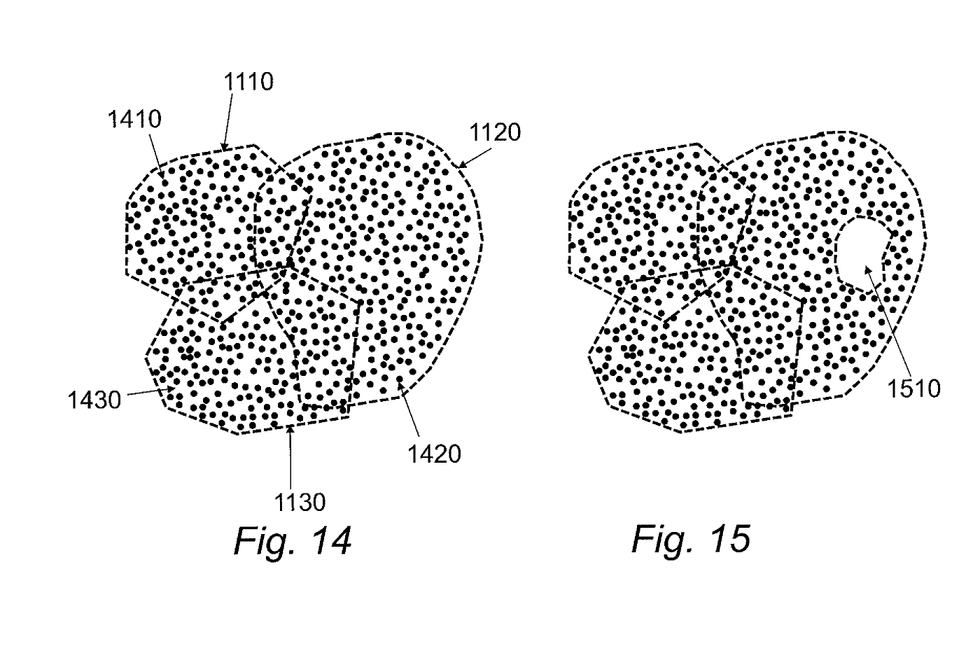

FIG. 14 illustrates the assignment of geolocations to internet users in the territories corresponding to the geolocation points of IP addresses according to an embodiment of the present invention. Once the territory 1110 corresponding to the geolocation point 810 of IP addresses has been determined in step 1060 (FIG. 10), and if this territory has not been judged to be too large in verification step 1070, a geolocation 1410 within the territory 1110 is assigned to any internet user whose IP address is geolocated at point 810 and who is not geolocated by a geolocation method other than geolocation by his IP address.

In the same way, once the territory 1120 corresponding to the geolocation point 820 of IP addresses has been determined in step 1060, and if this territory has not been judged to be too large in verification step 1070, a geolocation 1420 within the territory 1120 is assigned to any internet user whose IP address is geolocated at point 820 and who is geolocated only by his IP address.

In the same way, once the territory 1130 corresponding to the geolocation point 830 of IP addresses has been determined in step 1060, and if this territory has not been judged to be too large in verification step 1070, a geolocation 1430 within the territory 1130 is assigned to any Internet user whose IP address is geolocated at point 830 and who is geolocated only by his IP address, and so on.

FIG. 14 represents with dots the geolocations assigned to internet users 1410, 1420, 1430 whose IP addresses are geolocated at geolocation points of IP addresses 810, 820, 830 (see FIGS. 8, 9 and 11) and who are geolocated only by their IP addresses.

According to an embodiment of the present invention, the assignment of a geolocation to an internet user within the territory corresponding to the geolocation point of his IP address is made so as to obtain a substantially homogeneous distribution of geolocations of internet users.

According to an embodiment of the present invention, the assignment of a geolocation to an internet user within the territory corresponding to the geolocation point of his IP address is made so as to obtain a distribution of geolocations of internet users more homogeneous than the grouping of all the internet users at a single point.

According to an embodiment of the present invention, the assignment of a geolocation to an internet user within the territory corresponding to the geolocation point of his IP address is made randomly.

According to an embodiment of the present invention, the assignment of a geolocation to an internet user within the territory corresponding to the geolocation point of his IP address is made so as to obtain a harmonious distribution of geolocations of Internet users. For example, a territory corresponding to a geolocation point of IP addresses can be divided into several sub-territories in which the density of geolocations of internet users is evaluated. If a geolocation has to be assigned to a new Internet user, this geolocation will be preferentially chosen in the sub-territory with the lowest density of geolocations.

According to the embodiments of the present invention, the distribution of the geolocations of internet users is apparently uniform, or takes account of external parameters such as population density or traffic density.

According to an embodiment of the present invention, the assignment of a geolocation to an internet user within the territory corresponding to the geolocation point of his IP address is made across the entire territory.

FIG. 15 illustrates the assignment of geolocations to Internet users in territories corresponding to geolocation points of their IP addresses according to another embodiment of the present invention. The assignment of a geolocation to an Internet user within the territory corresponding to the geolocation point of his IP address can exclude a part 1510 of the territory such as an expanse of water or a forest.

According to an embodiment of the present invention, the assignment of a geolocation to an internet user within the territory corresponding to the geolocation point of his IP address takes account of the overlap of different territories corresponding to different geolocation points of IP addresses to distribute the geolocations of the internet users harmoniously and, in particular to avoid an excessive density of geolocations of internet users in the regions of overlap of several territories corresponding to several geolocation points of IP addresses. For example, the density of geolocations in the overlap zone can be evaluated and compared to the average density of geolocations for a territory or set of territories and, if a geolocation has to be assigned to a new internet user, this geolocation will not be chosen in the overlap zone if the density of geolocations there is substantially higher than the average density of geolocations of the territory or set of territories. This embodiment of the invention resolves a problem that could arise when the territories corresponding to various geolocation points of IP addresses overlap. If the assignment of the geolocation of the internet user does not take into account that the territory corresponding to his IP address and the other internet users whose IP addresses are geolocated at the same point as him, in other words, if the assignment does not take other territories into account, the area where several territories, corresponding to several IP addresses, overlap will have a higher density of internet users than the areas where a single territory exists.

Advantageously, in an embodiment of the invention, the assignment of a geolocation to the Internet user within the territory corresponding to the geolocation point of his IP address takes account of the Internet user's data. This data can come from the internet service provider, such as his IP address, from a form the internet user has previously completed, from a cookie or from another source. They can give indications as to the probable geolocation of the Internet user. For example, an Internet user located close to the Franco-Belgian frontier but using a Belgian access provider is more likely to be in Belgium than in France; or if he access a.be website he is also more likely to be in Belgium than in France.

According to an embodiment of the present invention, the assignment of a geolocation to an internet user within the territory corresponding to the geolocation point of his IP address takes account of the language that the internet user uses on the internet so as to determine on which side of a linguistic frontier to assign his geolocation.

According to an embodiment of the present invention, the assignment of a geolocation to an Internet user within the territory corresponding to the geolocation point of his IP address takes account of the origin, for example the domain name extension, of the site on which the internet user is surfing to assign him a geolocation.

According to an embodiment of the present invention, the assignment of a geolocation to an internet user within the territory corresponding to the geolocation point of his IP address takes account of the density of users located via their Internet browser and their geolocation service 280 or via the specification of their position on a platform 281 (see FIG. 10).

If a territory corresponding to a geolocation point has been judged as too large 1080 at the verification step 1070, any internet user whose IP address is geolocated at this point and who is geolocated only by his IP address is not assigned a precise geolocation, but is considered as an Internet user of a non-local territory for whom local advertisements are not pertinent. This Internet user will therefore not receive local advertising announcements but rather “non-local” advertising announcements, such as for example national or regional advertising announcements.

Other parameters can be taken into account for the assignment of a geolocation to an internet user within the territory corresponding to the geolocation point of his IP address, and it is understood that the present invention is in no way limited by the aforementioned embodiments of the invention.

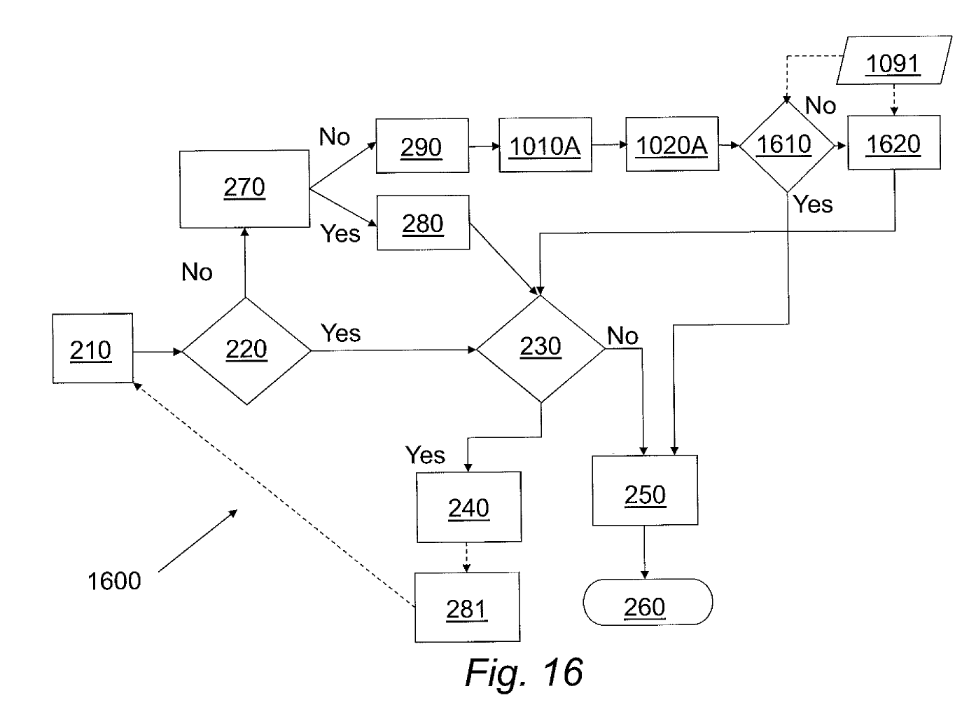

FIG. 16 illustrates an operating scheme 1600 of a communication system according to the present invention. According to a first route according to the operating scheme 1600, following calling of the advertising window 210 on the website consulted by the Internet user, the communication protocol HTTP (hypertext transfer protocol) 220 is checked by the internet browser to determine whether the internet user has already been geolocated previously and already possesses a cookie (evidence of connection), which makes it possible to determine whether the geolocation of said internet user is already recorded in a browser support, for example a fixed or portable computer, a data tablet, a mobile phone, or an augmented reality system. If the internet user has already been previously geolocated and if his geolocation has already been recorded in the communication system, said communication system will directly verify in the database comprising the advertising announcements 230 whether a local advertisement 240 can be displayed according to the precise geolocation of the internet user. If the Internet user's geolocation corresponds to a local advertising announcement 240, then this local advertising announcement 240 will be displayed.

Optionally, following the display of said local advertising announcement 240, if the internet user so desires he can, by clicking on a button (“other geolocation”) that directs him to a platform where he can modify the existing cookie, modify his geolocation more precisely by specifying it on said platform 281, for example by giving a postcode or a precise address. In this case, the previous cookie is erased from the browser support and replaced with the new one that is recorded in said browser support via said platform 281. Following this cookie changing operation, the communication system according to the invention starts again from the step of calling the advertising window 210.

As illustrated in FIG. 10, the IP address 1010 of the Internet user is used to determine the geolocation 1020 of his IP address, and the database 1040 then records the geolocation 1020 of his IP address as well as the geolocation 1050 specified by the internet user. Apart from these steps relating to FIG. 10 and which concern the collection of information for the database 1040, the first route according to the operating scheme 1600 is similar to the first route according to the operating scheme 200 illustrated in FIG. 2.

In the opposite case, if no local advertisement corresponds to the internet user's geolocation, then the communication system will go to a secondary program 250, which will allow a national advertising announcement 260 to be displayed.

According to a second route according to the operating scheme 1600, following calling of the advertising window 210 on the website consulted by the internet user, the communication protocol HTTP 220 is checked by the internet browser to determine whether the Internet user has already been geolocated previously and already possesses a cookie (evidence of connection), which makes it possible to determine whether the geolocation of said internet user is already recorded in a browser support, for example a fixed or portable computer, a data tablet, a mobile phone, or an augmented reality system. If the internet user has not yet been geolocated previously and if consequently his geolocation is not yet known by the internet browser, said internet browser will display a pop-up (message) 270 asking said internet user whether he wants to be geolocated. If the said Internet user refuses to be geolocated or ignores the pop-up, the communication system will use the said Internet user's IP address 1010A to determine the geolocation point 1020A of his IP address.

A verification step 1610 verifies if the geolocation point 1020A of the Internet user's IP address is known to regroup IP addresses located over a territory 1080 that is too large (see FIG. 10). This verification step 1610 is based on the data contained in the database 1091. If the territory is too large, a local advertisement might not be pertinent across the whole of this territory, and the communication system will go to a secondary program 250, which will allow a non-local advertising announcement 260 to be displayed. If the geolocation point 1020A of the internet user's IP address is not known to regroup IP addresses located over a territory 1090 that is too large, a geolocation 1620 is assigned to the said internet user within the territory corresponding to the geolocation point of his IP address.

The IP address of an internet user who has been identified in step 1610 as geolocated at a point regrouping IP addresses located over a territory 1080 that is too large (see FIG. 10), or who has been identified in step 1610 as geolocated at a point regrouping IP addresses located over a territory 1090 that is judged not “too large” determined at step 1060 is said to be “qualified”.

The geolocation assigned to an internet user leads to the creation of a cookie whose lifespan is variable depending on the browser support. For example, the lifespan of the cookie can be shorter for a mobile browser support than for a fixed browser support.

Following this geolocation 1620 assigned to the internet user, said communication system will directly verify in the database comprising the advertising announcements 230 whether a local advertisement 240 can be displayed according to the precise geolocation 1620 assigned to the internet user. If the geolocation assigned to the internet user corresponds to a local advertising announcement 240, then this local advertising announcement 240 will be displayed.

Optionally, following the display of said local advertising announcement 240, if the internet user so desires he can, by clicking on a button (“other geolocation”) that directs him to a platform where he can modify the existing cookie, modify his geolocation more precisely by specifying it on said platform 281, for example by giving a postcode or a precise address. In this case, the previous cookie is erased from the browser support and replaced with the new one that is recorded in said browser support via said platform 281. Following this cookie changing operation, the communication system according to the invention starts again from the step of calling the advertising window 210.

As illustrated in FIG. 10, the IP address 1010 of the internet user is used to determine the geolocation 1020 of his IP address, and the database 1040 then records the geolocation 1020 of his IP address as well as the geolocation 1050 specified by the internet user.

In the opposite case, if no local advertisement corresponds to the internet user's geolocation, then the communication system will go to a secondary program 250, which will allow a national advertising announcement 260 to be displayed.

According to a third route according to the operating scheme 1600, following calling of the advertising window 210 on the website consulted by the internet user, the communication protocol HTTP 220 is checked by the internet browser to determine whether the internet user has already been geolocated previously and already possesses a cookie (evidence of connection), which makes it possible to determine whether the geolocation of said internet user is already recorded in a browser support, for example a fixed or portable computer, a data tablet, a mobile phone, or an augmented reality system. If the Internet user has not yet been geolocated previously and if consequently his geolocation is not yet known by the internet browser, said Internet browser will display a pop-up (message) 270 asking said internet user whether he wants to be geolocated. If said Internet user accepts being geolocated, this geolocation is carried out via the internet browser and its geolocation service (“location service”) 280 making it possible to identify at least one SSID and/or identify the IP address and/or collect information on the 3G masts and/or picocells or femtocells and/or define the GPS and/or GPRS coordinates of said internet user. Acceptance of pop-up 270 leads to the creation of a cookie, whose lifetime is variable depending on the browser support. For example, the lifespan of the cookie can be shorter for a mobile browser support than for a fixed browser support.

As illustrated in FIG. 10, the IP address 1010 of the internet user is used to determine the geolocation 1020 of his IP address, and the database 1040 then records the geolocation 1020 of his IP address as well as the geolocation 1030 determined by the Internet user's internet browser.

Following this geolocation of the internet user, said communication system will directly verify in the database comprising the advertising announcements 230 whether a local advertisement 240 can be displayed according to the precise geolocation of the Internet user. If the Internet user's geolocation corresponds to a local advertising announcement 240, then this local advertising announcement 240 will be displayed.

Optionally, following the display of said local advertising announcement 240, if the internet user so desires he can, by clicking on a button (“other geolocation”) that directs him to a platform 281 where he can modify the existing cookie, modify his geolocation more precisely by specifying it on said platform 281, for example by giving a postcode or a precise address. In this case, the previous cookie is erased from the browser support and replaced with the new one that is recorded in said browser support via said platform 281. Following this cookie changing operation, the communication system according to the invention starts again from the step of calling the advertising window 210.

As illustrated in FIG. 10, the IP address 1010 of the Internet user is used to determine the geolocation 1020 of his IP address, and the database 1040 then records the geolocation 1020 of his IP address as well as the geolocation 1050 specified by the Internet user.

In the opposing case, if no local advertisement corresponds to the Internet user's geolocation, then the communication system will go to a secondary program 250, which will allow a national advertising announcement 260 to be displayed.

Apart from the steps relating to FIG. 10 and which concern the collection of information for the database 1040, the third route according to the operating scheme 1600 is similar to the third route according to the operating scheme 200 illustrated in FIG. 2.

According to an embodiment of the invention, local announcements are broadcast in priority to Internet users geolocated in the most precise way that is first to those who have specified their geolocation and then to internet used geolocated by their browser. If local announcements remain after the internet users geolocated by browser or browser geolocation system, or who have specified their location, have receive a local advertising announcement, they will then be broadcast to Internet users geolocated by their IP address in a territory corresponding to these local announcements. If no local announcements remain after broadcasting to the better geolocated Internet users, i.e. those geolocated by their browser or by specification of their geolocation, the internet users geolocated by their IP address will have a non-local advertising announcement.

It is of course understood that the present invention is not limited in any way to the embodiments described above and that many changes can be made to it while remaining within the scope of the appended claims.

1. A method of geolocation of an internet user whose IP address is known, that allows the determination of a geolocation point of his IP address, characterised in that the internet user is assigned a geolocation in a territory corresponding to the geolocation point of his IP address.

2. A method of geolocation according to claim 1, characterised in that the assignment to the said internet user of a geolocation within the territory corresponding to the geolocation point of his IP address is made so as to obtain a substantially homogeneous distribution of geolocations of internet users over the territories corresponding to the geolocation points of their IP addresses.

3. A method of geolocation according to claim 2, characterised in that the assignment to the said internet user of a geolocation within the territory corresponding to the geolocation point of his IP address is made so as to avoid an excessive density of geolocations of internet users in the regions where the territories corresponding to several geolocation points of IP addresses overlap.

4. A method of geolocation according to claim 1, characterised in that the assignment to the said internet user of a geolocation within the territory corresponding to the geolocation point of his IP address is made so as to exclude a part of the territory.

5. A method of geolocation according to claim 3, characterised in that the assignment to the said internet user of a geolocation within the territory corresponding to the geolocation point of his IP address is made so as to exclude a part of the territory.

6. A method of geolocation according to claim 1, characterised in that the assignment to the said Internet user of a geolocation within the territory corresponding to the geolocation point of his IP address takes account of the said internet user's data.

7. A method of geolocation according to claim 6, characterised in that the assignment to the said internet user of a geolocation within the territory corresponding to the geolocation point of his IP address takes account of the language in which the said internet user uses the internet.

8. A method of geolocation according to claim 1, characterised in that the territory corresponding to the geolocation point of the said internet user's IP address is determined by comparison of geolocation data by IP address and geolocation data from at least one other method of geolocation, the said data concerning several other internet users geolocated by their IP address and geolocated by at least one other method of geolocation.

9. A method of geolocation according to claim 8, characterised in that at least one other method of geolocation is performed via an internet browser and a geolocation service of this Internet browser.

10. A method of geolocation according to claim 9, characterised in that at least one other method of geolocation is performed via an internet browser and a geolocation service of this internet browser via the HTML5 technology or a later version of the HTML language system.

11. A method of geolocation according to claim 8, characterised in that at least one other method of geolocation is based on a geolocation carried out by an internet users from the plurality of other internet users who specify their geolocations themselves.

12. A method of geolocation according to claim 9, characterised in that at least one other method of geolocation is based on a geolocation carried out by an internet users from the plurality of other internet users who specify their geolocations themselves.

13. A method of geolocation according to claim 8, characterised in that a territory corresponding to a geolocation point of IP addresses includes substantially all the internet users from the plurality of other internet users whose IP address is geolocated at this point and who are geolocated by at least one other method of geolocation.

14. A method of geolocation according to claim 12, characterised in that a territory corresponding to a geolocation point of IP addresses includes substantially all the internet users from the plurality of other internet users whose IP address is geolocated at this point and who are geolocated by at least one other method of geolocation.

15. A method of geolocation according to claim 8, characterised in that the determination of the territory corresponding to a geolocation point of IP addresses comprises processing of geolocation data.

16. A method of geolocation according to claim 8, characterised in that the territory corresponding to a geolocation point of IP addresses has the form of a circle that passes through the two internet users from the plurality of other internet users most distant from one another whose IP address is geolocated at the said point and who are geolocated via at least one other method of geolocation.

17. A method of geolocation according to claim 8, characterised in that, if the IP address of the said internet user is geolocated at a point corresponding to a territory deemed too large based on a predefined criterion, the said internet user is assigned a geolocation at a national level.

18. A method of geolocation according to claim 8, characterised in that, if the IP address of the said internet user is geolocated at a point corresponding to a territory deemed too large based on a predefined criterion, the said [internet user] is assigned a geolocation at a non-local level.

19. A method of geolocation according to claim 1, characterised in that it is suitable for at least one of fixed and portable computers, data tablets, mobile phones (smartphones), systems equipped with a Wi-Fi system, digital televisions, radios and augmented reality systems.

20. A method of geolocation according to claim 8, characterised in that it is suitable for at least one of fixed and portable computers, data tablets, mobile phones (smartphones), systems equipped with a Wi-Fi system, digital televisions, radios and augmented reality systems.

21. A method of geolocation for broadcasting advertising announcements according to claim 1.

22. A method of geolocation for broadcasting advertising announcements according to claim 8.

23. A method of geolocation according to claim 22, characterised in that it is suitable for broadcasting local advertising announcements.

24. A method of geolocation for broadcasting advertising announcements according to claim 23, characterised in that the local advertising announcements are broadcast in priority to the internet users geolocated in the most precise way.

25. A computer program product characterised in that it is suitable for implementing the method of geolocation according claim 1.

26. A computer program product characterised in that it is suitable for implementing the method of geolocation according claim 8.

27. A communication system characterised in that it implements the method of geolocation according to claim 1.

28. A communication system characterised in that it implements the method of geolocation according to claim 8.

29. A communication system characterised in that it implements the method of geolocation according to claim 23.

30. A communication system according to claim 29, characterised in that it is appropriate for displaying advertising announcements.
